(19) United States
(12) Patent Application Publication
(10) Pub. No.: US 2016/0010543 A9
(43) Pub. Date: Jan. 14, 2016

(54) Fuel Processor With Mounting Manifold

(71) Applicant: WESTPORT POWER INC., Vancouver (CA)

(72) Inventors: Kalen Nathaniel Lees, Vancouver (CA); Minh C. Tran, Vancouver (CA)

(73) Assignee: WESTPORT POWER INC., Vancouver (CA)

(21) Appl. No.: 13/749,658

(22) Filed: Jan. 24, 2013

Related U.S. Application Data
(63) Continuation of application No. PCT/CA2011/000863, filed on Jul. 25, 2011.
(60) Provisional application No. 61/367,770, filed on Jul. 26, 2010.

(51) Int. Cl. F02B 43/00

(52) U.S. Cl. CPC F02B 43/00

(57) ABSTRACT

An engine system comprises a fuel processor that is supplied with air and a fuel reactant stream to produce a hydrogen-containing gas stream. The fuel processor comprises a mounting manifold, a housing, and an internal reaction chamber. The mounting manifold can fluidly interconnect an upstream engine exhaust conduit and a downstream engine exhaust conduit via internal passageways in the manifold, attach and position the fuel processor within the engine exhaust conduit, and fluidly connect external reactant supply conduits to the internal reaction chamber of the fuel processor.

### CROSS-REFERENCE TO RELATED APPLICATION(S)

This application is a continuation of International Application No. PCT/CA2011/000863, having an international filing date of Jul. 25, 2011, entitled “Fuel Processor With Mounting Manifold”. The '863 international application claimed priority benefits, in turn, from U.S. Provisional Patent Application Ser. No. 61/367,770 filed Jul. 26, 2010, also entitled “Fuel Processor With Mounting Manifold”. The '863 international application is hereby incorporated by reference herein in its entirety.

### FIELD OF THE INVENTION

The present invention relates to engine systems that include a fuel processor, and methods of operating engine systems that include a fuel processor for producing a hydrogen-containing gas stream, such as a syngas stream. The present apparatus and methods are particularly applicable to engine system applications where a hydrogen-containing gas is required, reduced fuel consumption is desired, and space is limited.

### BACKGROUND OF THE INVENTION

For engine systems in vehicular or other mobile applications where a supply of hydrogen is required, due to challenges related to on-board storage of a secondary fuel and the current absence of a hydrogen refueling infrastructure, hydrogen is preferably generated on-board using a fuel processor. The product stream from the fuel processor can be used to regenerate, desulfate and/or heat engine exhaust after-treatment devices, can be used as a supplemental fuel for the engine, and/or can be used as a fuel for a secondary power source, for example, a fuel cell.

One type of fuel processor is a syngas generator (SGG) that can convert a fuel into a gas stream containing hydrogen (H₂) and carbon monoxide (CO), known as syngas. Air or other oxygen-containing streams can be used as an oxidant for the fuel conversion process. Steam and/or water can optionally be added. The SGG can be conveniently supplied with a fuel comprising the same fuel that is used to operate the engine. Alternatively a different fuel can be used, although this would generally require a separate on-board secondary fuel source and supply system specifically for the SGG. The H₂ and CO can be beneficial in processes used to regenerate exhaust after-treatment devices. For other applications, such as use as a fuel in a fuel cell, the syngas stream may require additional processing prior to use. Fuel processors typically operate at temperatures of about 500° C.-1500° C.

In vehicular or other mobile applications, an on-board SGG should generally be fuel efficient, low cost, compact, light-weight and efficiently packaged with other components of the engine system. A fuel processor can advantageously be disposed within an engine exhaust conduit of an engine system in order to increase the fuel efficiency of the fuel processor by employing heat, that would be otherwise be dissipated into the atmosphere, in a downstream process or device and to reduce the volume of an exhaust after-treatment assembly of an engine system. Known methods of employing a fuel processor within an engine exhaust conduit include:
(a) integrating a fuel processor “in-line” with an engine exhaust conduit from the engine, and employing the engine exhaust stream as the oxidant reactant for the fuel processor, for example, as illustrated in FIG. 1 and described in more detail below; and
(b) integrating a fuel processor comprising a substantially closed “reaction chamber” within a shell or housing, within an engine exhaust conduit, for example, as illustrated in FIG. 2 and described in more detail below.

FIG. 1 is a simplified schematic diagram illustrating a conventional, prior art engine system 1 in which a fuel processor 6 is configured “in-line” with engine exhaust conduit sections 3 and 5, and exhaust after-treatment assembly 4 of an engine system 1. An engine 2 produces an exhaust stream that exits engine 2 and flows through engine exhaust conduit 3, and then directly into fuel processor 6, and on into exhaust after-treatment assembly 4 before exiting into the atmosphere via conduit 5. Exhaust after-treatment assembly 4 can comprise one or more devices that can reduce regulated emissions, for example, a diesel oxidation catalyst (DOC), a lean NO trap (LNT), a selective catalytic reduction (SCR) device, and/or a diesel particulate filter (DPF). Some or all of the devices in exhaust after-treatment assembly 4 can at least periodically be heated or regenerated by a product stream from fuel processor 6. Some or all of the oxygen-containing exhaust stream from engine 2 is employed as the oxidant reactant for fuel processor 6. For example, engine system 1 can be configured such that substantially the entire exhaust stream from engine 2 and/or exhaust conduit 3 is directed through fuel processor 6 (as shown in FIG. 1), or so that a portion of the engine exhaust stream is directed through fuel processor 6 (for example, there could be a bypass conduit or another conduit for the remainder of the exhaust stream). When a product stream is desired from fuel processor 6, fuel from fuel tank 7 is introduced via fuel conduit 8 into engine exhaust conduit 3, and mixes with the engine exhaust stream upstream of fuel processor 6. Fuel processor 6 typically comprises a monolith with a catalytic washcoat, which can catalytically convert the combined fuel and engine exhaust stream into a product stream. The combined engine exhaust gas and/or fuel processor product stream flows into exhaust after-treatment assembly 4, where it may be employed, before flowing into conduit 5 and exiting into the atmosphere. Optionally the product stream from fuel processor 6 can be diverted to devices or other components (not shown in FIG. 1) in engine system 1 via valves and conduits.

Some shortcomings associated with configuring a fuel processor “in-line” with the engine exhaust conduit and exhaust after-treatment assembly, where the exhaust stream of an engine is employed as the oxidant reactant in the fuel processor, include the following:
(a) Some parameters of the exhaust stream produced by the engine, such as mass flow, pressure, temperature, composition and emission levels, vary significantly over the operating range and operating condition of the engine. If the fuel processor employs an engine exhaust stream as the oxidant reactant, the variable parameters affect the ability to accurately and repeatedly control the air-fuel ratio of the reactants and resulting product stream output of the fuel processor.
(b) The product stream output required from the fuel processor is typically variable. A hydrogen-containing or hot gas stream is preferably generated as-needed in accordance with the variable demand from devices in the engine system, and independent of the operating condition of the engine. For example, the demand for product stream from the fuel processor may be great during periods when the exhaust stream has a reduced concentration of oxygen.
(c) An in-line configuration of the fuel processor is suitable only for engine systems and operating conditions where the exhaust stream of the engine contains an appropriate level of oxygen. For example, it may be limited to lean burn engine systems where a sufficient level of oxygen is present in the exhaust stream over a large portion of the operating range.
(d) The fuel processor can be operated only when the engine is producing an exhaust stream.

FIG. 2 is a simplified schematic diagram illustrating a conventional, prior art engine system 21 in which a fuel processor 26, is located within an engine exhaust conduit 23. Engine 22 produces an exhaust stream that exits engine 22 and flows through engine exhaust conduit 23, and on into exhaust after-treatment assembly 24 before exiting into the atmosphere via engine exhaust conduit 25. Exhaust after-treatment assembly 24 can comprise one or more devices that can reduce regulated emissions as described above in reference to FIG. 1.

Fuel processor 26 comprises a housing 31 that encloses an interior reaction chamber (not shown in FIG. 2) where fuel reforming and oxidation reactions occur. Various conduits (for example, product stream conduit, not shown in FIG. 2), equipment (for example, a glow plug, not shown in FIG. 2), and sensors (for example, temperature and pressure sensors, not shown in FIG. 2) can be fluidly connected to the reaction chamber, attached to housing 31. These penetrate or traverse radially through engine exhaust conduit 23 so that they can be attached to various appropriate connectors (not shown in FIG. 2) external to engine exhaust conduit 23. Fuel processor 26 is located within engine exhaust conduit 23 so that during operation of engine 22, heat transfer between fuel processor 26 and the engine exhaust stream occurs. For example, fuel processor 26 is configured so that at least a portion of the exhaust stream from engine 22 can flow over at least a portion of housing 31, and so that exhaust stream can beneficially transfer sensible heat from fuel processor 26 to downstream exhaust after-treatment assembly 24, and can keep the fuel processor warm when the fuel processor is not operating.

The reaction chamber of fuel processor 26 is supplied with air (or another oxygen-containing stream) via oxidant conduit 30 and blower 29, rather than receiving engine exhaust from engine exhaust conduit 23. Optional devices (not shown in FIG. 2) including, for example, valves, filters, sensors, metering devices, can be employed along oxidant conduit 30. A fuel reactant stream from fuel tank 27 is introduced into fuel processor 26, via fuel conduit 28. This can be the same tank from which fuel is supplied to engine 22, or can be a separate tank. Optional devices (not shown in FIG. 2) including, for example, valves, filters, sensors, a fuel pump and/or fuel metering device, can be employed along fuel conduit 28. The supply of fuel and oxidant reactant streams and operation of fuel processor 26 can be controlled by a controller, not shown in FIG. 2. The product stream can exit fuel processor 26 through an outlet port (not shown in FIG. 2), into the exhaust stream, at conditions desired for regeneration of downstream exhaust after-treatment devices. The combined engine exhaust and SGG product stream flows into exhaust after-treatment assembly 24, where it may be converted, before flowing into engine exhaust conduit 25 and exiting into the atmosphere. Optionally the product stream from the fuel processor 26 can be diverted to other devices or other components (not shown in FIG. 2) in engine system 21 via valves and conduits.

Challenges associated with integrating and operating a fuel processor comprising a housing within an engine exhaust conduit can include:
(a) requiring complex apparatus to attach and position the fuel processor within the engine exhaust conduit,
(b) requiring complex apparatus and assembly methods to connect the various conduits, equipment and sensors to the fuel processor and to their respective connections external to the engine exhaust conduit,
(c) during operation of the engine system and fuel processor, the fuel processor, engine exhaust conduit and associated components can be subject to different degrees of thermal expansion. This can cause mechanical stress on components that penetrate through the engine exhaust conduit and attach to the fuel processor housing. This can reduce the durability and operational lifetime of the fuel processor.

In the present approach a fuel processor is integrated within an engine exhaust conduit and engine system in such a way that at least some of the challenges discussed above are addressed.

### SUMMARY OF THE INVENTION

In one aspect, an engine system comprises:
(a) an engine that during operation produces an exhaust stream;
(b) a fuel processor for producing a product stream, the fuel processor further comprising:
   (i) a mounting manifold;
   (ii) a housing coupled to the mounting manifold; and
   (iii) a reaction chamber defined at least in part by the housing;
(c) an upstream engine exhaust conduit located between the engine and the fuel processor;
(d) a downstream engine exhaust conduit located downstream of the fuel processor;

wherein the mounting manifold attaches and positions the housing within the downstream engine exhaust conduit. The mounting manifold comprises a passageway that fluidly interconnects the upstream engine exhaust conduit with the downstream engine exhaust conduit, and further comprises at least one port for connecting the reaction chamber to a reactant supply conduit.

In another aspect, an engine system comprises:
(a) an engine that during operation produces an exhaust stream;
(b) a fuel processor for producing a product stream, the fuel processor further comprising:
   (i) mounting manifold;
   (ii) a housing coupled to the mounting manifold, and
   (iii) a reaction chamber defined at least in part by the housing,
(c) an engine exhaust conduit connected to receive the exhaust stream from the engine, and
(d) an exhaust after-treatment assembly, located downstream of the fuel processor, for at least periodically reducing regulated emissions in the exhaust stream,

wherein the mounting manifold attaches and positions the housing within the engine exhaust conduit. The mounting manifold comprises a passageway that fluidly interconnects the engine exhaust conduit with the exhaust after-treatment assembly, and further comprises at least one reactant supply port for connecting the reaction chamber to a reactant supply conduit.

In one aspect, a fuel processor comprises:
(a) a mounting manifold;
(b) a housing coupled to the mounting manifold, and
(c) a reaction chamber defined at least in part by the housing,

wherein the mounting manifold is for attaching and positioning the housing within a surrounding conduit. The mounting manifold comprises a passageway that fluidly interconnects upstream and downstream portions of the surrounding conduit, and further comprises at least one port for connecting the reaction chamber to a reactant supply conduit.

In one aspect of a method of operating an engine system comprising an engine, an engine exhaust conduit, and a fuel processor located within the engine exhaust conduit, the fuel processor comprising a mounting manifold coupled to a housing, and a reaction chamber defined at least in part by the housing, the method comprises:
(a) operating the engine system to produce an engine exhaust stream;
(b) introducing a fuel and an oxidant reactant stream into the reaction chamber via the mounting manifold and operating the fuel processor to produce a product stream; and
(c) directing at least a portion of the engine exhaust stream through a passageway within the mounting manifold, into the engine exhaust conduit and over at least a portion of the fuel processor housing.

In some embodiments of the method, during operation of the fuel processor, sensible heat is transferred to the engine exhaust stream via the housing.

In another aspect of a method of operating an engine system comprising an engine, an exhaust after-treatment assembly, and a fuel processor comprising a mounting manifold coupled to a housing, and a reaction chamber defined at least in part by the housing, the method comprises:
(a) operating the engine system to produce an engine exhaust stream;
(b) directing at least a portion of the engine exhaust stream to at least one exhaust after-treatment device in the exhaust after-treatment assembly, for reducing regulated emissions in the engine exhaust stream;
(c) introducing a fuel and an oxidant reactant stream into the reaction chamber via the mounting manifold and operating the fuel processor to produce a product stream; and
(d) at least periodically introducing at least a portion of the product stream into the exhaust after-treatment device for heating or regenerating the exhaust after-treatment device,

wherein during operation of the engine at least a portion of the engine exhaust stream flows through a passageway within the mounting manifold, over at least a portion of the fuel processor housing and into the exhaust after-treatment assembly.

In some embodiments of the method, during operation of the fuel processor, sensible heat is transferred to the engine exhaust stream via the housing, and is beneficially employed in the exhaust after-treatment assembly.

The product stream from the fuel processor is preferably a hydrogen-containing gas stream such as a syngas stream, or is a flue gas stream.

In one aspect of a method of operating a fuel processor comprising a mounting manifold coupled to a housing, and a reaction chamber defined at least in part by the housing, the method comprises:
(a) directing a process stream through passageways in the mounting manifold and over at least a portion of the housing, and
(b) introducing a fuel and an oxidant reactant stream into the reaction chamber via the mounting manifold and operating the fuel processor to produce a product stream and sensible heat;

wherein during operation of the fuel processor sensible heat is transferred to the process stream via the housing.

In some embodiments of the method of operating the fuel processor, the sensible heat is beneficially employed by a downstream device and/or process from the fuel processor.

In some embodiments of the method of operating the fuel processor, the product stream is beneficially employed by a downstream device and/or process from the fuel processor.

In some embodiments of the method of operating the fuel processor, the product stream is introduced into the process stream and beneficially employed by a downstream device and/or process from the fuel processor.

### BRIEF DESCRIPTION OF THE DRAWINGS

FIG. 1 is a simplified schematic diagram illustrating a conventional, prior art engine system configuration comprising a fuel processor, where the fuel processor is configured “in-line” with the exhaust conduit from the engine. The fuel processor is directly fluidly connected to the engine so that at least a portion of the engine exhaust stream is employed as the oxidant reactant in the fuel processor.

FIG. 2 is a simplified schematic diagram of a conventional, prior art engine system configuration comprising a fuel processor, with the fuel processor located within an engine exhaust conduit and upstream of an exhaust after-treatment assembly. The fuel processor employs an oxidant reactant that is supplied from an external source, for example, an air blower.

FIG. 3a is a simplified schematic diagram of a preferred embodiment of an engine system comprising a fuel processor or syngas generator (SGG) comprising a mounting manifold, with the fuel processor located upstream of an exhaust after-treatment assembly.

FIG. 3b is an exploded perspective view of a preferred embodiment of a syngas generator (SGG) as illustrated in FIG. 3a.

FIG. 4a is a perspective view of an embodiment of a mounting manifold for a fuel processor.

FIG. 4b is an end view of the mounting manifold illustrated in FIG. 4a.

FIG. 4c is a cross-sectional view of the mounting manifold illustrated in FIG. 4b, along section A-A.

FIG. 5a is a simplified sectional view of an embodiment of a fuel processor with a mounting manifold illustrating an optional configuration where a reactant stream is introduced along the longitudinal axis of the fuel processor and the mounting manifold defines a portion of the reaction chamber.

FIG. 5b is a simplified sectional view of an embodiment of a fuel processor with a mounting manifold illustrating an optional configuration where the fuel processor housing is attached to the mounting manifold, with the housing defining most of the reaction chamber.

FIG. 5c is a simplified sectional view of an embodiment of a fuel processor with a mounting manifold illustrating an optional configuration comprising two reactant ports, oriented radially to the axis of the fuel processor, for introducing reactants to the reaction chamber of the fuel processor. The mounting manifold defines a portion of the reaction chamber.

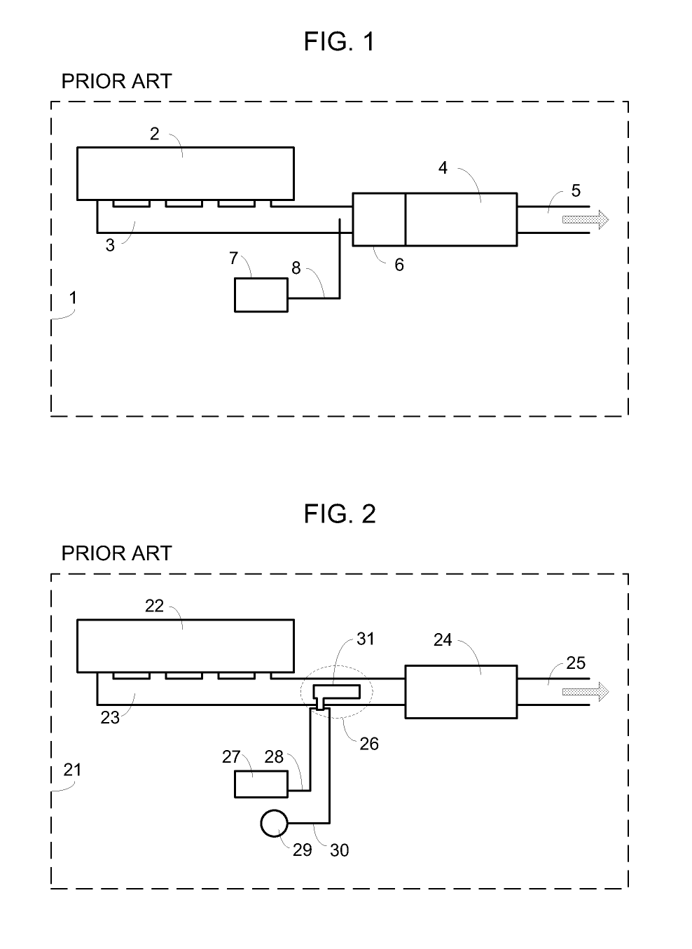

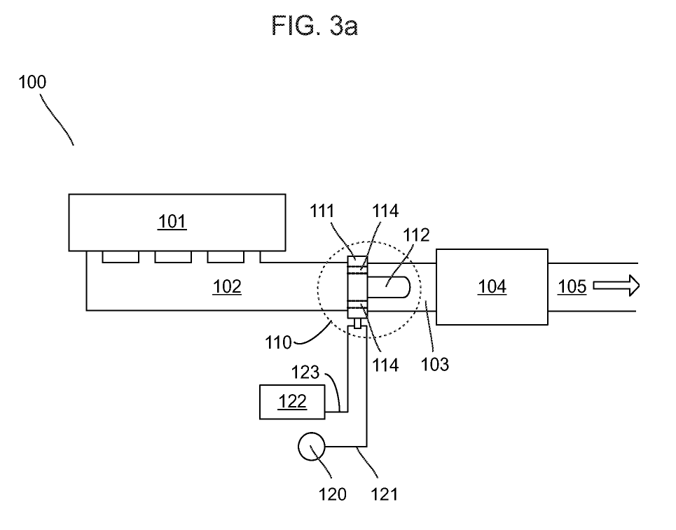

### DETAILED DESCRIPTION OF PREFERRED EMBODIMENT(S)

In embodiments of the present system and method, an engine system comprises a fuel processor, such as a syngas generator (SGG), with a mounting manifold. The mounting manifold attaches and positions a housing of the fuel processor within an engine exhaust conduit, so that during operation, heat transfer between the housing and the engine exhaust stream occurs. For example, the housing can be positioned axially or concentrically within the conduit by the mounting manifold so that the housing is substantially surrounded by the engine exhaust stream. The heat can be beneficially employed by a downstream process or device. The mounting manifold also fluidly connects one or more reactant supply conduits to a reaction chamber located internal to the housing of the fuel processor, as well as fluidly interconnecting upstream and downstream portions of the engine exhaust conduit in which it is located. Optionally, some or all equipment, instrumentation and sensors associated with the fuel processor can be attached to the mounting manifold and connect to the reaction chamber via passageways within the mounting manifold. This can reduce the quantity of devices that connect to the inner housing of a fuel processor by passing through the surrounding engine exhaust conduit. The fuel processor can produce a product stream, for example, a hydrogen-containing gas stream, syngas stream and/or flue gas stream, that can be beneficially employed by a downstream device or process including, for example, to regenerate or enhance the performance of one or more exhaust after-treatment devices, as a supplemental fuel for an engine, as a fuel for a fuel cell, and/or other hydrogen consuming devices.

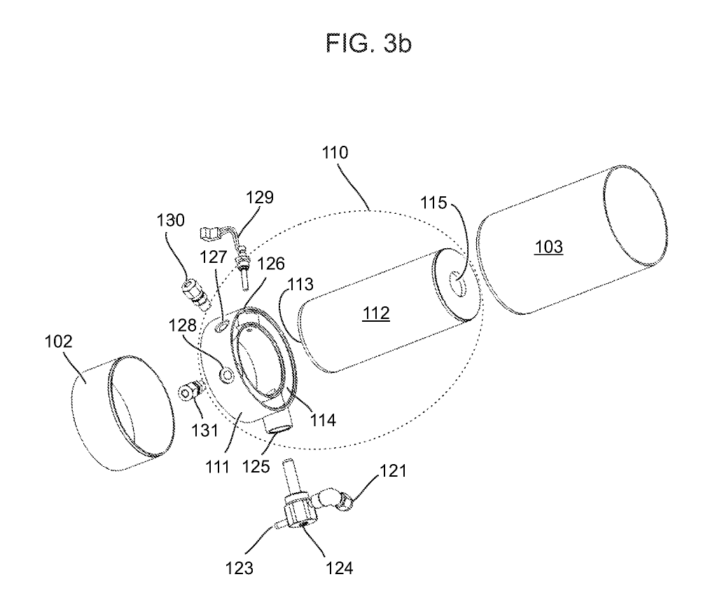

FIG. 3a is a simplified schematic diagram of a preferred embodiment of an engine system 100 comprising engine 101 and a fuel processor 110 comprising a mounting manifold 111 and housing 112. Fuel processor 110 is preferably a syngas generator (SGG). Mounting manifold 111 fluidly interconnects engine exhaust conduits 102 and 103. Engine 101 produces an exhaust stream that flows into engine exhaust conduit 102, through annular exhaust passageway 114 within mounting manifold 111, through exhaust conduit 103, and on into exhaust after-treatment assembly 104 and outlet conduit 105, before exiting into the atmosphere. FIG. 3b is an exploded view of a preferred embodiment of a syngas generator (SGG) as illustrated in FIG. 3a. Engine 101 can be, for example, a lean burn combustion engine. Exhaust after-treatment assembly 104 can reduce the amount of regulated emissions in the exhaust stream and can include one or more valves, sensors, conduits, branches and/or exhaust after-treatment devices including, for example, a diesel oxidation catalyst (DOC), lean NO trap (LNT), selective catalytic reduction (SCR), and/or diesel particulate filter (DPF). SGG 110 comprising mounting manifold 111 can be interposed at a suitable location between engine 101 and exhaust after-treatment assembly 104 where the product stream and/or sensible heat transferred from SGG 110 can be employed to regenerate one or more devices in exhaust after-treatment assembly 104. Optionally one or more exhaust after-treatment devices can be located upstream of the fuel processor, and one or more exhaust legs and/or exhaust after-treatment devices can be configured in parallel downstream of one or more fuel processors.

SGG 110 can reach extreme temperatures during its operation and can produce a product stream that can be hot, flammable, and hazardous. For example, SGG 110 can be a non-catalytic partial oxidation fuel processor which during normal operation can reach temperatures up to about 1400° C. Locating housing 112 within engine exhaust conduit 103 can offer protection from the extreme temperatures and can act to contain leakage of potentially flammable and harmful gases from the SGG should leakage occur. This containment feature can reduce the requirement for flammable and/or hazardous gas sensors, enable a higher operating pressure for the SGG and/or offer the advantages of reducing the complexity, cost, weight and volume of SGG 110. Furthermore, locating SGG housing 112 within engine exhaust conduit 103 can reduce the need for a product stream conduit and diverter valve, which can advantageously reduce the pressure drop across SGG 110, and/or reduce the power required and energy consumed to compress the oxidant reactant stream supplied to SGG 110, and/or reduce the complexity, cost, weight and volume of SGG 110.

In the embodiment of FIG. 3a, SGG 110 can be supplied with an externally supplied oxidant reactant stream, for example, a compressed air stream, via oxidant reactant supply conduit 121 and blower 120. Optional devices (not shown in FIG. 3a) including, for example, valves, filters, sensors, metering devices, can be employed along oxidant reactant supply conduit 121. SGG 110 can be supplied with a fuel reactant stream, for example, diesel, from fuel tank 122 via fuel reactant supply conduit 123. This can be the same tank from which fuel is supplied to engine 101, or can be a separate tank. Optional devices (not shown in FIG. 3a) including, for example, valves, filters, sensors, a fuel pump and/or fuel metering device, can be employed along fuel reactant supply conduit 123. The supply of fuel and oxidant reactant streams and operation of SGG 110 can be controlled by a controller (not shown in FIG. 3a or 3b). Some or all of the product stream can exit SGG 110 through a product stream port 115 (shown in FIG. 3b), into the exhaust stream, at conditions desired for regeneration of exhaust after-treatment devices. The equivalence ratio (ER) of the reactants introduced into a SGG 110 can be adjusted to change various parameters of the product stream including, for example, production of a syngas stream or a flue gas stream. The term “equivalence ratio” herein refers to the ratio between the actual amount of oxygen supplied and the theoretical stoichiometric amount of oxygen that would be required for complete conversion of the fuel. An ER of greater than 1 represents a fuel lean mode (excess oxygen) that typically creates a flue gas stream, while an ER of less than 1 represents a fuel rich mode (excess fuel) that typically creates a syngas stream. The combined engine exhaust gas and SGG product stream mixes and flows through exhaust stream conduit 103 and into exhaust after-treatment assembly 104, where it may be employed, before flowing into exit conduit 105 and exiting into the atmosphere. Optionally, product stream from SGG 110 can be diverted to other hydrogen-consuming devices or other components (not shown in FIG. 3a or 3b) in engine system 100 via valves and conduits (not shown in FIG. 3a or 3b). SGG 110 can be operated when the engine is not running or substantially independently of engine operation.

Turning to FIG. 3b, SGG 110 comprises mounting manifold 111, and housing 112 that encloses an interior reaction chamber 113 (not shown in FIG. 3a) where fuel reforming and oxidation reactions occur. Mounting manifold 111 can fluidly interconnect an upstream engine exhaust conduit 102 to a downstream exhaust conduit 103 and can be coupled between the conduits using appropriate hardware, for example, bolted flanges or other suitable connectors. Exhaust passageway 114 in mounting manifold 111 fluidly interconnects engine exhaust conduits 102 and 103. Mounting manifold 111 can attach and position housing 112 within exhaust conduit 103, can allow housing 112 to thermally expand independent of exhaust conduit 103, and can simplify and reduce the cost of incorporating and assembling SGG 110 within engine system 100.

Various reactant supply conduits, equipment, instrumentation, and sensors can be attached to the external perimeter or outer body of the mounting manifold 111. This can simplify and reduce the cost of assembly, and reduce stresses and constraints that can be caused by thermal expansion. Optionally, the center of the ports where the various devices attach to a mounting manifold can be positioned along a single plane perpendicular to the longitudinal axis of a SGG as shown in FIG. 3b. This can further reduce constriction and stress along the longitudinal axis of the SGG.

An oxidant reactant stream, for example, air, can be supplied to reaction chamber 113 of SGG 110 via oxidant reactant supply conduit 121, reactant introduction assembly 124 and reactant port 125 of mounting manifold 111. A fuel reactant stream, for example, diesel, can be supplied to reaction chamber 113 of SGG 110 via fuel reactant supply conduit 123, reactant introduction assembly 124 and reactant port 125 of mounting manifold 110. Oxidant reactant supply conduit 121 and fuel reactant supply conduit 123 are fluidly connected within reactant introduction assembly 124, where the oxidant and fuel reactant streams are combined and mixed, forming a mixed reactant stream. The mixed reactant stream can then be introduced into reaction chamber 113 tangentially relative to the longitudinal axis of the reaction chamber. Other fuel and/or oxidant introduction devices can be employed, for example, a fuel injector and/or an air assist nozzle. Other fuel and/or oxidant introduction configurations with mounting manifold 111 can be employed, for example, the mixed reactant stream can be introduced along the longitudinal axis of the reaction chamber 113 or at some other angle, more than one mixed reactant stream can be introduced into a reaction chamber 113 via separate ports and devices, fuel and oxidant reactant streams can be introduced into a reaction chamber via separate ports without being pre-mixed at one or multiple introduction ports.

An ignition device, for example, a glow plug, can be activated by a controller (not shown in FIGS. 3a and 3b) to ignite a mixed reactant stream in reaction chamber 113 when desired. Glow plug 129 can optionally be attached to mounting manifold 111 at port 126, and can be located in close proximity downstream of and in-line with the path of the mixed reactant stream as it enters reaction chamber 113. One or more sensors can be employed to sense parameters within reaction chamber 113, for example, temperature and/or pressure sensors. Sensors 130 and 131 can be attached to mounting manifold 111 at ports 127 and 128 respectively. The center of reactant port 125, and ports 126, 127 and 128, are positioned on a single plane.

The mixed reactant stream is converted to a product stream within reaction chamber 113 before exiting SGG 110 via product stream port 115. Additional conduits, valves or other devices (not shown in FIGS. 3a and 3b) can be employed to direct and control the flow of the product stream to one or more devices, for example, exhaust after-treatment devices that employ the product stream.

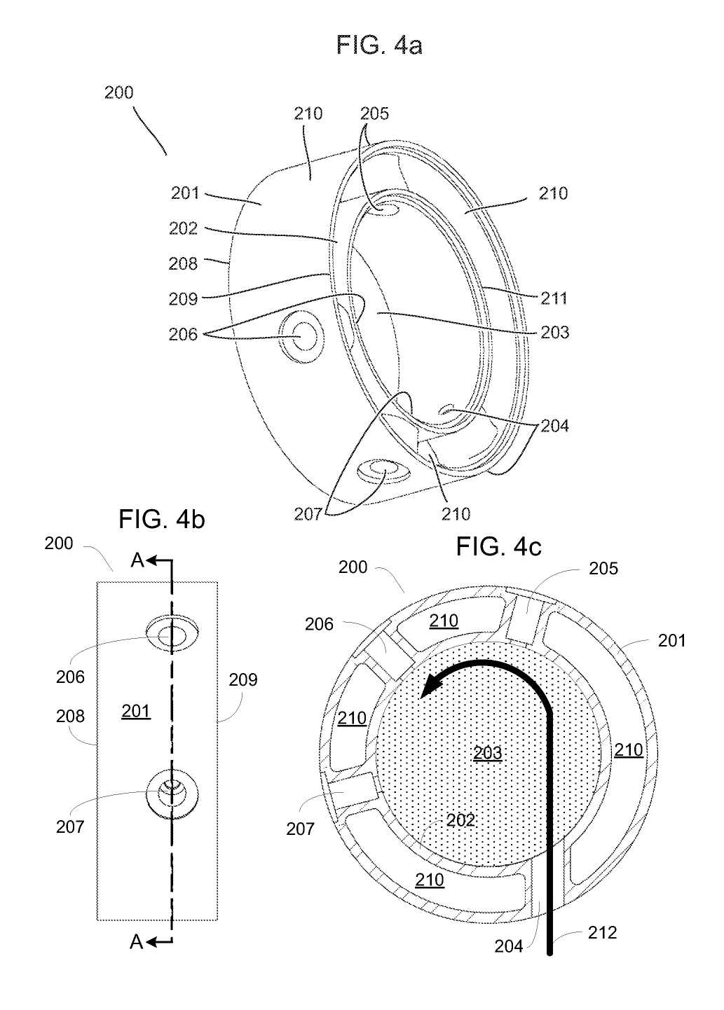

Turning to FIGS. 4a, 4b and 4c, a perspective view of an embodiment of mounting manifold 200 for a fuel processor is shown in FIG. 4a. FIG. 4b is an end view of the mounting manifold illustrated in FIG. 4a. FIG. 4c is a cross-sectional view of the mounting manifold illustrated in FIG. 4b, along section A-A. Mounting manifold 200 comprise an outer body 201, inner body 202, end cap 203, reactant port 204, and ports 205, 206 and 207. Mounting manifold 200 can be fabricated from one or more pieces by suitable manufacturing processes from suitable materials. For example, end cap 203 can optionally be fabricated as a separate component or as part of inner body 202. Inner body 202 can optionally define a portion of the fuel processor reaction chamber. The fuel processor housing (not shown in FIGS. 4a, 4b and 4c) can define and contain the remaining portion of the reaction chamber or optionally the entire reaction chamber, and can be positioned and attached to inner body 202 at face 211. Appropriate features, for example, a bore, a boss, a flange, a thread, and/or a groove, can be incorporated at face 211, to allow the attachment of the fuel processor housing. Preferably, mounting manifold 200 is fabricated as a cast single or unitary component that can reduce manufacturing costs. More preferably, mounting manifold 200 and the fuel processor housing (not shown in FIGS. 4a, 4b and 4c) are cast together as a single or unitary component further reducing manufacturing costs.

One or more voids or conduits are formed between outer body 201 and inner body 202, forming engine exhaust passageways 210 that can fluidly interconnect an upstream engine exhaust conduit with a downstream engine exhaust conduit. An upstream engine exhaust conduit (not shown in FIGS. 4a, 4b and 4c) can be attached to face 208 and a downstream engine exhaust conduit (not shown in FIGS. 4a, 4b and 4c) can be attached to face 209 of mounting manifold 200. Appropriate features, for example, a bore, a boss and/or a flange, can be incorporated at face 208 and face 209 to allow the attachment of the corresponding engine exhaust conduits, and the features can be the same or differ on each face and conduit. Features (not shown in FIGS. 4a, 4b and 4c) can be incorporated into mounting manifold 200, inner body 202, end cap 203, and/or exhaust passageways 210 to reduce the pressure drop of the exhaust stream as it flows to a downstream engine exhaust conduit via mounting manifold from the upstream engine exhaust conduit.

A reactant introduction assembly (not shown in FIGS. 4a, 4b and 4c) can be attached to outer body 201 and reactant port 204 which can be positioned to introduce a mixed reactant stream tangentially into the reaction chamber, as illustrated by arrow 212 in FIG. 4c. Tangential entry of the mixed reactant stream into a reaction chamber can cause the mixed reactant stream to travel in a cyclonic or spiraling path which can beneficially increase residence time of the reactant stream (when compared to axial entry along the longitudinal axis of a reaction chamber), increase turbulence, improve mixing and distribution of the mixed reactant stream, and/or reduce the size and quantity of dead zones (space with little or low reactant stream flow). Reduced dead zones within a reaction chamber can increase the effective reaction time even when the hydraulic residence time is not altered, which can result in increasing the syngas output from a given size of fuel processor. Hydraulic residence time can be calculated from a superficial or theoretical total reactor volume and gas volumetric flow. The enhanced turbulence and mixing of the mixed reactant stream can enhance reaction kinetics and fuel conversion efficiency, while reducing hydrocarbon slip. Introducing a mixed reactant stream into a reaction chamber tangentially can also result in increasing the turn-down ratio of the fuel processor.

An ignition device and various sensors or instruments (not shown in FIGS. 4a, 4b and 4c) can be attached to outer body 201 via ports 205, 206 and 207.

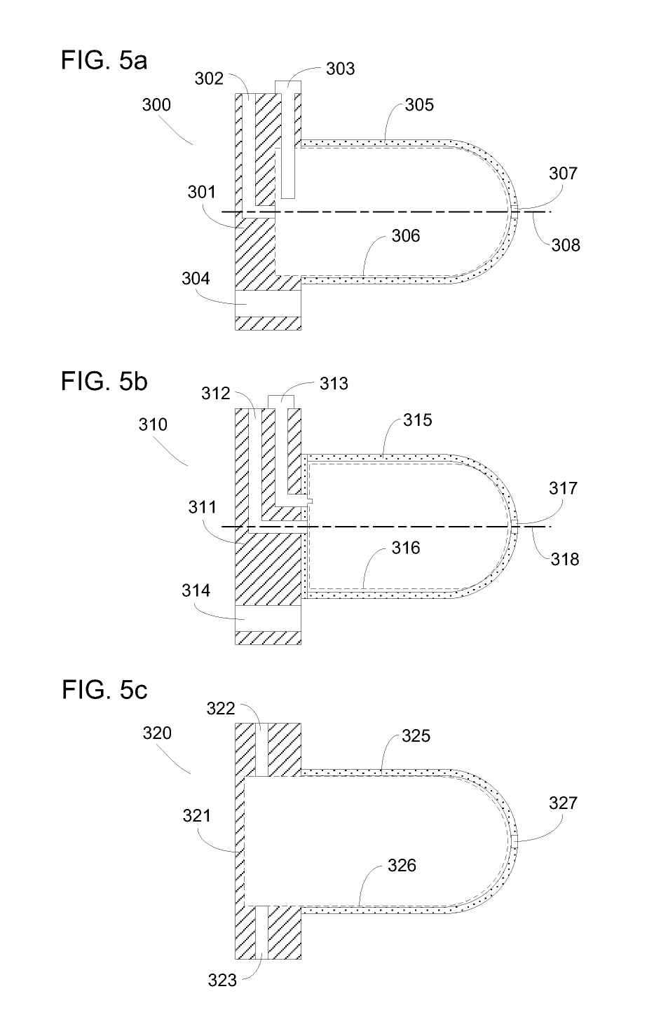

FIGS. 5a, 5b and 5c, are simplified sectional views of embodiments of fuel processors comprising a mounting manifold with different configurations. The possible configurations are not limited to those illustrated in FIGS. 5a, 5b, and 5c. In FIG. 5a, SGG 300 comprises a mounting manifold 301 and housing 305. A reactant supply conduit (not shown in FIG. 5a) can be attached to mounting manifold 301 at port 302 to supply a reactant stream to reaction chamber 306 via port 302. Port 302 and/or a reactant introduction device (not shown in FIG. 5a) can be configured to introduce the reactant stream along longitudinal axis 308 of reaction chamber 306 as shown in the embodiment of FIG. 5a. An ignition device 303 can be employed to initiate the reforming reactions, while the product stream can exit SGG 300 through port 307. Upstream and downstream engine exhaust conduits (not shown in FIG. 5a) can be attached to mounting manifold 301 with one or more passageway(s) 304 fluidly connecting the upstream engine exhaust conduit with the downstream engine exhaust conduit, enabling the flow of engine exhaust through mounting manifold 301. Mounting manifold 301 defines and contains a portion of reaction chamber 306. Additional ports (not shown in FIG. 5a) within mounting manifold 301 can fluidly connect reaction chamber 306 to external conduits or devices (not shown in FIG. 5a).

In FIG. 5b, SGG 310 comprises a mounting manifold 311 and housing 315 which defines essentially the entire reaction chamber. A reactant supply conduit (not shown in FIG. 5b) can be attached to mounting manifold 311 at port 312 to supply a reactant stream to reaction chamber 316 via port 312. Port 312 and/or a reactant introduction device (not shown in FIG. 5b) can optionally be configured to introduce the reactant stream along longitudinal axis 318 of reaction chamber 316. An ignition device 313 can be employed to initiate the reforming reactions, while the product stream can exit SGG 310 through port 317. Upstream and downstream engine exhaust conduits (not shown in FIG. 5b) can be attached to mounting manifold 311. Passageways(s) 314 can fluidly connect the upstream engine exhaust conduit with the downstream engine exhaust conduit, enabling the flow of an engine exhaust stream through mounting manifold 311. Additional ports (not shown in FIG. 5b) within mounting manifold 311 can fluidly connect reaction chamber 316 to external conduits or devices (not shown in FIG. 5b).

In FIG. 5c, SGG 320 comprises a mounting manifold 321 with reactant supply ports 322 and 323 and housing 325. Reactant supply conduits (not shown in FIG. 5c) can be attached to mounting manifold 321 at ports 322 and 323 to supply reactant stream to reaction chamber 326 via port 322 and 323. Ports 322, 323 and/or reactant introduction devices (not shown in FIG. 5c) can optionally be configured to introduce the reactant stream tangentially relative to reaction chamber 326, and can supply a mixed reactant stream or a single reactant stream, for example, a fuel or oxidant reactant, through each individual port. An ignition device (not shown in FIG. 5c) can be employed to initiate the reforming reactions, while the product stream can exit SGG 320 through port 327. Upstream and downstream engine exhaust conduits (not shown in FIG. 5c) can be attached to mounting manifold 321. One or more process stream passageways (not shown in FIG. 5c) within mounting manifold 321 can fluidly connect the upstream engine exhaust conduit with the downstream engine exhaust conduit, enabling the flow of an engine exhaust stream through mounting manifold 321. Mounting manifold 321 defines and contains a portion of reaction chamber 326. Additional ports (not shown in FIG. 5c) within mounting manifold 321 can fluidly connect reaction chamber 326 to external conduits, devices, or reactant supply conduits (not shown in FIG. 5c).

In the above-described embodiments, a mounting manifold:
(a) is coupled to the fuel processor housing,
(b) attaches and fluidly connects one or more external reactant supply conduits to the internal reaction chamber of the fuel processor, and
(c) fluidly interconnects an upstream engine exhaust conduit to a downstream engine exhaust conduit.

The mounting manifold can optionally:
(a) be used to connect various equipment, instruments and sensors including, for example, glow plug, temperature and/or pressure sensors, to the reaction chamber of an associated fuel processor; and/or
(b) define and contain part of the fuel processor reaction chamber; and/or
(c) position the fuel processor within an engine exhaust conduit; and/or
(d) transfer heat to or from a fuel processor; and/or
(e) reduce the pressure drop or alter the flow of the engine exhaust stream as it flows within an engine exhaust conduit and past a fuel processor

In preferred embodiments of the systems and methods described above, the fuel processor is a syngas generator that is a non-catalytic partial oxidation reformer that during normal operation is operated to produce a syngas or flue gas stream. However, the mounting manifold and associated fuel processor integration into an engine system and the operating methods described herein can be implemented for various types of fuel processors including SGGs, reformers or other reactors used to produce hydrogen-containing gas streams. These can be of various types, for example, catalytic partial oxidizers, non-catalytic partial oxidizers, and/or autothermal reformers. Suitable reforming and/or water-gas shift catalyst can be employed in the fuel processor.

The fuel supplied to the fuel processor can be a liquid fuel (herein meaning a fuel that is a liquid when under International Union of Pure and Applied Chemistry (IUPAC) defined conditions of standard temperature and pressure) or a gaseous fuel. Suitable liquid fuels include, for example, diesel, gasoline, kerosene, liquefied natural gas (LNG), fuel oil, methanol, ethanol or other alcohol fuels, liquefied petroleum gas (LPG), or other liquid fuels from which hydrogen can be derived. Alternative gaseous fuels include natural gas and propane.

The fuel processor can be deployed in various end-use mobile or stationary engine system applications where a hydrogen-consuming device is employed and/or hot gas is needed. The product stream can be directed to one or more hydrogen-consuming devices for example an exhaust after-treatment device, a fuel cell, or a combustion engine.

In preferred embodiments of the systems and methods described above, the engine is a lean burn combustion engine. However, the engine can be a near stoichiometric air-to-fuel ratio type engine. Suitable fuels supplied to the engine include, for example, diesel, gasoline, kerosene, liquefied natural gas (LNG), fuel oil, methanol, ethanol or other alcohol fuels, liquefied petroleum gas (LPG), jet, biofuel, natural gas or propane.

In preferred embodiments of the systems and methods described above, an engine produces an exhaust stream which flows through passageways in the mounting manifold of the fuel processor and into an exhaust after-treatment system. However, a source for the fluid stream which passes through the mounting manifold and over the fuel processor housing can be other than an engine, the fluid stream can be other than an engine exhaust gas stream, and the device and/or process which employ a product stream and/or sensible heat produced by the fuel processor can be other than an engine exhaust after-treatment device.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

What is claimed is:

1. An engine system comprising:
(a) an engine that during operation produces an exhaust stream;
(b) a fuel processor for producing a product stream, said fuel processor further comprising:
(i) a mounting manifold;
(ii) a housing coupled to said mounting manifold, and
(iii) a reaction chamber defined at least in part by said housing,
(c) an upstream engine exhaust conduit located between said engine and said fuel processor;
(d) a downstream engine exhaust conduit located downstream of said fuel processor;
wherein said mounting manifold attaches and positions said housing within said downstream engine exhaust conduit, and wherein said mounting manifold comprises a passageway that fluidly interconnects said upstream engine exhaust conduit with said downstream engine exhaust conduit, and further comprises at least one port for connecting said reaction chamber to a reactant supply conduit.

2. The engine system of claim 1 wherein said mounting manifold defines a portion of said reaction chamber.

3. The engine system of claim 1 wherein said mounting manifold further comprises an access port for coupling a sensor to said reaction chamber.

4. The engine system of claim 1 wherein said mounting manifold further comprises an ignition device for initiating a reaction within said reaction chamber.

5. The engine system of claim 1 wherein said passageway in said mounting manifold is substantially annular.

6. The engine system of claim 1, said system further comprising a hydrogen-consuming device, wherein said fuel processor further comprises a product stream conduit to supply a hydrogen-containing product stream to said hydrogen consuming device.

7. The engine system of claim 1 wherein said housing is substantially cylindrical, and said mounting manifold attaches and positions said housing substantially axially within said downstream engine exhaust conduit.

8. An engine system comprising:
(a) an engine that during operation produces an exhaust stream;
(b) a fuel processor for producing a product stream, said fuel processor further comprising:
(i) a mounting manifold;
(ii) a housing coupled to said mounting manifold, and
(iii) a reaction chamber defined at least in part by said housing,
(c) an engine exhaust conduit connected to receive said exhaust stream from said engine, and
(d) an exhaust after-treatment assembly, located downstream of said fuel processor, for at least periodically reducing regulated emissions in said exhaust stream,
wherein said mounting manifold attaches and positions said housing within said engine exhaust conduit, and wherein said mounting manifold comprises a passageway that fluidly interconnects said engine exhaust conduit with said exhaust after-treatment assembly, and further comprises at least one reactant supply port for connecting said reaction chamber to a reactant supply conduit.

9. The engine system of claim 8 wherein said mounting manifold defines a portion of said reaction chamber.

10. The engine system of claim 8 wherein said mounting manifold further comprises an access port for coupling a sensor to said reaction chamber.

11. The engine system of claim 8 wherein said mounting manifold further comprises an ignition device for initiating a reaction within said reaction chamber.

12. The engine system of claim 8 wherein said passageway in said mounting manifold is substantially annular.

13. The engine system of claim 8, said system further comprising a hydrogen-consuming device, wherein said fuel processor further comprises a product stream conduit to supply a hydrogen-containing product stream to said hydrogen consuming device.

14. The engine system of claim 8 wherein said exhaust after-treatment assembly is connected to selectively receive said product stream from said fuel processor.

15. A fuel processor comprising:
(a) a mounting manifold;
(b) a housing coupled to said mounting manifold, and
(c) a reaction chamber defined at least in part by said housing,
wherein said mounting manifold is for attaching and positioning said housing within a surrounding conduit, wherein said mounting manifold comprises a passageway that fluidly interconnects upstream and downstream portions of said surrounding conduit, and further comprises at least one port for connecting said reaction chamber to a reactant supply conduit.

16. A method of operating an engine system comprising an engine, an engine exhaust conduit, and a fuel processor located within said engine exhaust conduit, said fuel processor comprising a mounting manifold coupled to a housing, and a reaction chamber defined at least in part by said housing, said method comprising:
(a) operating said engine system to produce an engine exhaust stream;
(b) introducing a fuel and an oxidant reactant stream into said reaction chamber via said mounting manifold and operating said fuel processor to produce a product stream; and
(c) directing at least a portion of said engine exhaust stream through a passageway within said mounting manifold, into said engine exhaust conduit and over at least a portion of said fuel processor housing.

17. The method of claim 16 wherein, during operation of said fuel processor, sensible heat is transferred to said engine exhaust stream via said housing.

18. A method of operating an engine system comprising an engine, an exhaust after-treatment assembly, and a fuel processor comprising a mounting manifold coupled to a housing, and a reaction chamber defined at least in part by said housing, said method comprising:
(a) operating said engine system to produce an engine exhaust stream;
(b) directing at least a portion of said engine exhaust stream to at least one exhaust after-treatment device in said exhaust after-treatment assembly, for reducing regulated emissions in said engine exhaust stream;
(c) introducing a fuel and an oxidant reactant stream into said reaction chamber via said mounting manifold and operating said fuel processor to produce a product stream; and
(d) at least periodically introducing at least a portion of said product stream into said exhaust after-treatment device for heating or regenerating said exhaust after-treatment device,
wherein during operation of said engine at least a portion of said engine exhaust stream flows through a passageway within said mounting manifold, over at least a portion of said fuel processor housing and into said exhaust after-treatment assembly.

19. The method of claim 18 wherein, during operation of said fuel processor, sensible heat is transferred to said engine exhaust stream via said housing, and said sensible heat is beneficially employed in said exhaust after-treatment assembly.

20. The method of claim 18 wherein said product stream is a syngas stream.

21. The method of claim 18 wherein said product stream is a flue gas stream.

22. The method of claim 18 wherein said fuel reactant stream and said oxidant reactant stream are introduced tangentially into to said reaction chamber.

23. A method of operating a fuel processor comprising a mounting manifold coupled to a housing, and a reaction chamber defined at least in part by said housing, said method comprising:
(a) directing a process stream through passageways in said mounting manifold and over at least a portion of said housing, and
(b) introducing a fuel and an oxidant reactant stream into said reaction chamber via said mounting manifold and operating said fuel processor to produce a product stream and sensible heat;
wherein during operation of said fuel processor sensible heat is transferred to said process stream via said housing.

24. The method of claim 18 wherein said sensible heat is beneficially employed by a downstream device or process from said fuel processor.

25. The method of claim 18 wherein said product stream is beneficially employed by a downstream device or process from said fuel processor.

26. The method of claim 18 wherein said product stream is introduced into said process stream and beneficially employed by a downstream device and/or process from said fuel processor.
